(19) United States
(12) Patent Application Publication
(10) Pub. No.: US 2025/0103038 A1
(43) Pub. Date: Mar. 27, 2025

(54) METHOD FOR DETECTING ABNORMAL WORKING CONDITIONS OF MULTI-VIEW DATA BASED ON FEATURE REGRESSION

(71) Applicant: Northeastern University, Shenyang City (CN)

(72) Inventors: Chuan MA, Shenyang City (CN); Yingwei ZHANG, Shenyang City (CN); Lin FENG, Shenyang City (CN)

(21) Appl. No.: 18/724,548

(22) PCT Filed: Jan. 11, 2022
(86) PCT No.: PCT/CN2022/071326

§ 371 Date: Jun. 26, 2024

(51) Int. Cl. G05B 23/02; G05B 19/418

(52) U.S. Cl. CPC G05B 23/0281; G05B 19/4184

(57) ABSTRACT

Provided is a method for detecting abnormal working conditions of multi-view data based on feature regression. By the method, data capable of being acquired in a production process is collected together, a big data pool is established, and historical data information is fully utilized; by analyzing the data in the data pool, the method for detecting abnormal working conditions based on the multi-view data is established by a feature regression method, and a general mathematical model is established for preprocessed data acquired by different sensors; left and right projection vectors solved through the model can make similar sample points have better clustering effects in a low dimensional space; and by comparing a correlation between vectors after dimensionality reduction and various category vectors, production working conditions at a current time can be recognized.

### BACKGROUND OF THE INVENTION

### 1. Field of the Invention

The present invention relates to the technical field of fault detection and diagnosis, in particular to a method for detecting abnormal working conditions of multi-view data based on feature regression.

### 2. The Prior Arts

With the development of science and technological progress, industrial systems have become increasingly large and complex. Once these systems fail, they will cause huge property damage and casualties. Therefore, improving reliability and maintainability of complex dynamic systems has become a primary issue for enterprise development. A data-based fault diagnosis technology refers to establishment of appropriate mathematical models for industrial processes through various data processing methods, statistical modeling methods, etc. based on massive data acquired in actual industrial production processes, thereby achieving the purpose of detecting and diagnosing whether faults occur in the processes. Research on this technology not only has much theoretical significance, but also has a wide range of application backgrounds, and thus it is an important development direction for a future fault diagnosis technology.

An industrial production process is a complex and changeable process, and occurrence of faults is caused by multiple reasons. Data from a single data source can only detect a single abnormal working condition during fault detection, and cannot comprehensively and accurately detect the entire production process. Therefore, collaborative modeling should be performed on multi-source heterogeneous data generated in the production process, and a comprehensive mathematical model at a data structure level is established to diagnose the production process comprehensively and improve its automation level. However, inconsistency of data categories poses significant difficulties for modeling.

### SUMMARY OF THE INVENTION

The technical problem to be solved by the present invention is to provide a method for detecting abnormal working conditions of multi-view data based on feature regression to address shortcomings of the prior art. By collecting data that can be acquired in production processes, a big data pool is established. By analyzing the data in the data pool, a general collaborative modeling algorithm based on multi-source heterogeneous data is established to achieve comprehensive diagnosis of the production processes.

In order to solve the above technical problems, the present invention adopts the following technical solutions: the method for detecting abnormal working conditions of multi-view data based on feature regression includes the following steps.

Step 1: acquiring sample data under different working conditions in an actual industrial production process, denoted as {Xⱼⁱ|i=1, 2, . . . , w; j=1, 2, . . . , n}, where Xⱼⁱ is j^{th} sample data in an i^{th} view, w is the number of views, and n is the number of samples under different views.

Step 2: preprocessing the acquired sample data under different working conditions.

If the sample data Xⱼⁱ in the i^{th} view is image data, firstly performing graying processing and normalization processing on the image data, then obtaining an average value {X̅^{ih}|h=1, 2, . . . , r} of all data under different working conditions according to the acquired sample data, where r is the number of working condition categories, and further obtaining the preprocessed sample data:

$${X}_{j}^{′ i} = [ {X}_{j}^{i} - {\overline{X}}^{i 1} , {X}_{j}^{i} - {\overline{X}}^{i 2} , … , {X}_{j}^{i} - {X}^{ir} ] . \qquad ( 1 )$$

If the sample data Xⱼⁱ∈i^{q×1} in the i^{th} view is vector data, the preprocessed sample data is:

$${X}_{j}^{′ i} = [ \begin{matrix}{e}^{- \frac{\vert {x}_{j 1}^{i} - {\overline{x}}_{1}^{i 1}}{{β}_{1} {σ}_{11}}} & {e}^{- \frac{\vert {x}_{j 1}^{i} - {\overline{x}}_{1}^{i 2}}{{β}_{2} {σ}_{21}}} & … & {e}^{- \frac{\vert {x}_{j 1}^{i} - {\overline{x}}_{1}^{ir}}{{β}_{r} {σ}_{r 1}}} \\ {e}^{- \frac{\vert {x}_{j 2}^{i} - {\overline{x}}_{2}^{i 1}}{{β}_{1} {σ}_{12}}} & {e}^{- \frac{\vert {x}_{j 2}^{i} - {\overline{x}}_{2}^{i 2}}{{β}_{2} {σ}_{22}}} & … & {e}^{- \frac{\vert {x}_{j 2}^{i} - {\overline{x}}_{2}^{i r}}{{β}_{r} {σ}_{r 2}}} \\ ⋮ & ⋮ & ⋱ & ⋮ \\ {e}^{- \frac{\vert {x}_{jq}^{i} - {\overline{x}}_{q}^{i 1}}{{β}_{1} {σ}_{1 q}}} & {e}^{- \frac{\vert {x}_{j q}^{i} - {\overline{x}}_{q}^{i 2}}{{β}_{2} {σ}_{2 q}}} & … & {e}^{- \frac{\vert {x}_{jq}^{i} - {\overline{x}}_{q}^{i r}}{{β}_{r} {σ}_{rq}}}\end{matrix} ] . \qquad ( 2 )$$

Wherein Xⱼ^{ri} represents the preprocessed sample data of the sample data Xⱼⁱ, x_{jq}ⁱ represents q^{th} variable of the sample data Xⱼⁱ, x̅_{q}^{ir} and σ_{rq} represent an average value and a standard deviation of the q^{th} variable in the i^{th} view under an r^{th} working condition, respectively, and {βⱼ|j=1, 2, . . . , r} represents coefficient parameter variables under different working conditions.

Step 3: after preprocessing the sample data, establishing the method for detecting abnormal working conditions based on the multi-view data by the feature regression method, wherein an objective function model is:

$$L ( {u}^{i j} , {v}^{i j} , {p}^{j} ) = {\sum }_{l = 1}^{n} {\sum }_{i = 1}^{w} {\sum }_{j = 1}^{r} {( {u}^{i j} {X}_{l}^{i} {v}^{i j} - {y}_{l}^{i j} {p}^{j} )}^{2} + {λ}_{2} {\sum }_{i = 1}^{w} {‖ {M}^{i} ‖}_{F}^{2} + {λ}_{1} {\sum }_{i = 1}^{w} {\sum }_{j = 1}^{r} {( {u}^{ij} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{ij} )}^{2} . \qquad ( 3 )$$

Wherein Xₗⁱ∈i^{d×m} is l^{th} preprocessed sample data in the i^{th} view, d and m are dimensions of the sample data Xₗⁱ, and u^{ij}∈i^{l×d} and v^{ij}∈i^{m×1} are left and right projection vectors, respectively; X_{f}ⁱ and X_{g}ⁱ are f^{th} preprocessed sample data and g^{th} preprocessed sample data in the i^{th} view, respectively; p^{j} is a regression center of the sample data in all views under a j^{th} working condition; yₗ^{ij} is a label of l^{th} sample data in the i^{th} view, if Xₗⁱ belongs to the j^{th} working condition, yₗ^{ij}=1, otherwise, yₗ^{ij}=0; λ₁ and λ₂ are both coefficient parameters.

### Setting

$${\hat{y}}_{l}^{i} = {[ {k}_{l}^{i 1} , {k}_{l}^{i 2} , … {k}_{l}^{ir} ]}^{T} \qquad ( 4 )$$

$$and$$

$${ω}_{l} = {\sum }_{i = 1}^{w} cos 〈 {\hat{y}}_{l}^{i} , {1}_{( r \times 1 )} 〉 . \qquad ( 5 )$$

Wherein

$${k}_{l}^{ir} = \frac{{u}^{ij} {X}_{l}^{i} {v}^{ij}}{{p}^{j}} ,$$

for i=1, 2, . . . , n, largest t data labels corresponding to ωₗ constitute a set {Ω}, {C_{f}ⁱ} is a label set of sample data in a same category as the preprocessed sample data X_{f}ⁱ.

### Defining

$$\{ {G}_{f}^{i} \} = \{ {C}_{f}^{i} \} - \{ Ω \} \qquad ( 6 )$$

$$and$$

$${M}^{i} = [ {v}^{i 1} {u}^{i 1} , {v}^{i 2} {u}^{i 2} , … , {v}^{ir} {u}^{ir} ] . \qquad ( 7 )$$

Step 3.1: solving the objective function model.

The above objective function model (3) is decomposed into w×r optimization problems, namely rewritten as:

$$L ( {u}^{i j} , {v}^{i j} , {p}^{j} ) = {\sum }_{l = 1}^{n} {( {u}^{i j} {X}_{l}^{i} , {v}^{i j} - {y}_{l}^{i j} {p}^{j} )}^{2} + {λ}_{2} {‖ {v}^{i j} {u}^{i j} ‖}_{F}^{2} + {{λ}_{1} ( {u}^{i j} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{i j} )}^{2} . \qquad ( 8 )$$

Step 3.2: fixing v^{ij} and p^{j}, and solving u^{ij}.

Letting

$$T = {\sum }_{f ∈ \{ Ω \}} {ω}_{f} {\sum }_{g ∈ \{ {G}_{f}^{i} \}} ( {X}_{f}^{i} - {X}_{g}^{i} ) . \qquad ( 9 )$$

Taking a partial derivative of formula (8) with respect to u^{ij} and letting the partial derivative be equal to 0 to obtain:

$${u}^{ij} = \frac{{\sum }_{l = 1}^{n} ( {y}_{l}^{ij} {{p}^{j} ( {X}_{l}^{i} {v}^{j} )}^{T} )}{{{λ}_{2} ( {v}^{ij} )}^{T} {v}^{ij}} \times {\{ \frac{{\sum }_{l = 1}^{n} ( {X}_{l}^{i} {{v}^{ij} ( {X}_{l}^{i} {v}^{ij} )}^{T} ) + {λ}_{1} T {{v}^{ij} ( T {v}^{ij} )}^{T}}{{{λ}_{2} ( {v}^{ij} )}^{T} {v}^{ij}} + {I}_{1} \}}^{- 1} . \qquad ( 10 )$$

Where I₁ is a unit matrix of d×d.

Step 3.3: fixing u^{ij} and p^{j}, and solving v^{ij}.

Taking a partial derivative of formula (8) with respect to vᵢⱼ and letting the partial derivative be equal to 0 to obtain:

$${v}^{i j} = {\{ \frac{{\sum }_{l = 1}^{n} ( {( {u}^{i j} {X}_{l}^{i} )}^{T} {u}^{i j} {X}_{l}^{i} ) + {{λ}_{1} ( {u}^{i j} T )}^{T} {u}^{i j} T}{{λ}_{2} {{u}^{i j} ( {u}^{i j} )}^{T}} + {I}_{2} \}}^{- 1} \times \frac{{\sum }_{l = 1}^{n} ( {( {u}^{i j} {X}_{l}^{i} )}^{T} {y}_{l}^{i j} {p}^{j} )}{{λ}_{2} {{u}^{i j} ( {u}^{i j} )}^{T}} . \qquad ( 11 )$$

Where I₂ is a unit matrix of m×m.

Step 3.4: fixing u^{ij} and v^{ij}, and solving p^{j}.

Further rewriting the rewritten objective function model (8) as:

$$L ( {p}^{j} ) = {\sum }_{l = 1}^{n} {\sum }_{i = 1}^{w} {( {u}^{i j} {X}_{l}^{i} {v}^{i j} - {y}_{l}^{i j} {p}^{j} )}^{2} . \qquad ( 12 )$$

Taking a partial derivative of formula (12) with respect to p^{j} and letting the partial derivative be equal to 0 to obtain:

$${p}^{j} = \frac{{\sum }_{l = 1}^{n} {\sum }_{i = 1}^{w} {( {y}_{l}^{i j} {u}^{i j} {X}_{l}^{i} {v}^{i j} )}^{2}}{{\sum }_{l = 1}^{n} {\sum }_{i = 1}^{w} {y}_{l}^{i j}} . \qquad ( 13 )$$

Step 3.5: using the obtained u^{ij}, v^{ij} and p^{j} for next iteration and performing loop iteration until the objective function model converges to a minimum value or satisfies termination conditions.

Step 3.5.1: solving ωₗ, {Ω} and {G_{f}ⁱ}, respectively, through formulas (4), (5) and (6).

Step 3.5.2: solving u^{ij} through formula (10).

Step 3.5.3: solving v^{ij} through formula (11).

Step 3.5.4: solving p^{j} through formula (13).

Step 3.5.5: determining whether the termination conditions are satisfied, if yes, outputting u^{ij}, v^{ij} and p^{j}, or else, repeating Steps 3.5.1-3.5.4.

Step 4: performing on-line abnormal working condition detection by the method for detecting abnormal working conditions based on the multi-view data.

Acquiring sample data {X_{new}ⁱ|i=1, 2, . . . , w} at a certain time, and performing preprocessing by the data preprocessing method in Step 2; performing dimensionality reduction on the sample data at the certain time by using the left projection vector u^{ij} and the right projection vector v^{ij} obtained from Step 3, and constituting a vector y_{new} after the dimensionality reduction; selecting data category vectors y* according to requirements, wherein for the data category vectors, since sample point data at every time can only belong to one category, for each view, only one data category vector is 1, and the rest are 0; therefore, for the data category vectors y*, w 1s exist, all other w×(r−1) variables are 0; wherein

$${y}_{new} = {[ \begin{matrix}\frac{{u}^{11} {X}_{new}^{1} {v}^{11}}{{p}^{1}} & \frac{{u}^{12} {X}_{new}^{1} {v}^{12}}{{p}^{2}} & … & \frac{{u}^{1 r} {X}_{new}^{1} {v}^{1 r}}{{p}^{r}} & \frac{{u}^{21} {X}_{new}^{2} {v}^{21}}{{p}^{1}} & … & \frac{{u}^{wr} {X}_{new}^{w} {v}^{wr}}{{p}^{r}}\end{matrix} ]}^{T} \qquad ( 14 )$$

$$and$$

$${y}^{*} = {[ \begin{matrix}{y}^{11} & {y}^{12} & … & {y}^{1 r} & {y}^{21} & … & {y}^{wr}\end{matrix} ]}^{T} . \qquad ( 15 )$$

Based on similarity between y_{new} and y*, determining a category of working conditions at the certain time, and using cosine similarity as a detection index, wherein a calculation method of the detection index is:

$${CS}_{new} = 1 - cos 〈 {y}_{new} , {y}^{*} 〉 . \qquad ( 16 )$$

By comparing values of detection indexes of different data category vectors y* and y_{new}, determining working conditions at a current time, wherein the smaller the values of the detection indexes, the greater a correlation between y* and y_{new}; due to different data category vectors y* under different working conditions, working conditions corresponding to the data category vector with a smallest value of the detection index are selected as working conditions at the current time.

The beneficial effect of adopting the above technical solutions is that in the method for detecting abnormal working conditions of multi-view data based on feature regression provided by the present invention, a new data preprocessing method is adopted, and historical data information is fully utilized, thereby making differences between different categories of data greater after preprocessing, and providing more reliable information for subsequent working condition recognition. A general mathematical model is established for the preprocessed data acquired by different sensors. The left and right projection vectors solved by the model can make similar samples have better clustering effects in low dimensional space. By comparing a correlation between vectors after dimensionality reduction and various category vectors, the production working conditions at the current time can be quickly and accurately recognized.

### BRIEF DESCRIPTION OF DRAWINGS

FIG. 1 shows a schematic structural diagram of a production process of an electric melting magnesium furnace provided in an embodiment of the present invention;

FIG. 2 shows a flow diagram of a method for detecting abnormal working conditions of multi-view data based on feature regression provided in an embodiment of the present invention;

FIG. 3 shows a diagram including original data and data obtained through data preprocessing of images under normal and abnormal working conditions provided by an embodiment of the present invention, wherein (a) shows image data acquired at a certain time under normal working conditions, (b) shows image data acquired at a certain time under abnormal working conditions, (c) shows data obtained through data preprocessing of the image data in (a), and (d) shows data obtained through data preprocessing of the image data in (b);

FIG. 4 shows physical variable data and the data obtained through data preprocessing provided in an embodiment of the present invention, where (a) shows a data matrix composed of 498 physical variable data acquired for testing, and (b) shows a data matrix consisting of vector data recombined from each test sample data obtained through data preprocessing in (a); and

FIG. 5 shows a diagram of detection results of each sample point under the working conditions provided in an embodiment of the present invention.

In drawings, 1: transformer; 2: short mesh; 3: electrode lifting apparatus; 4: electrode; 5: furnace shell; 6: vehicle body; 7: electric arc; and 8: furnace burden.

### DETAILED DESCRIPTION OF THE PREFERRED EMBODIMENT

The further detailed description of embodiments of the present invention will be provided in combination with the accompanying drawings and embodiments. The following embodiments are used to illustrate the present invention, but are not intended to limit the scope of the present invention.

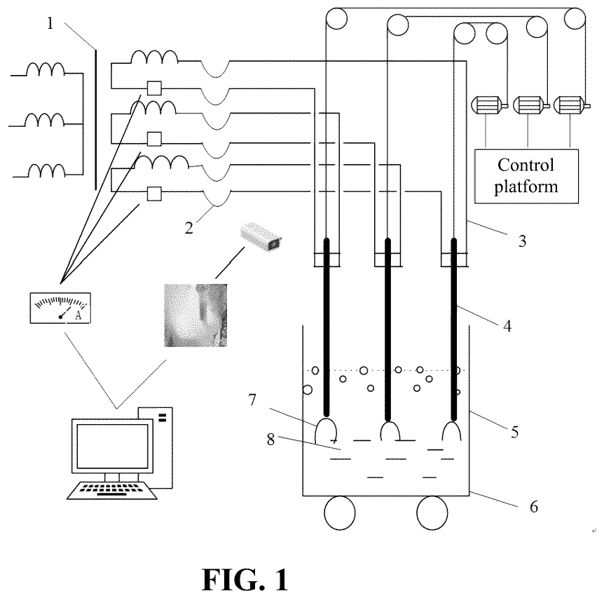

A production process of an electric melting magnesium oxide furnace (referred to as electric melting magnesium furnace) is shown in FIG. 1. Herein, the electric melting magnesium furnace includes a transformer 1, a short mesh 2, an electrode lifting apparatus 3, an electrode 4, a furnace shell 5, a vehicle body 6, an electric arc 7, and furnace burdens 8. The electric melting magnesium furnace mainly uses material resistance heat generated by currents passing through materials in a molten state as a main heat source, accompanied by arc heat. The heat of the electric melting magnesium furnace is concentrated and can effectively heat the materials to a melting point above 2800° C., which is conducive to melting of electric melting magnesium sand. The embodiment takes the production process of the electric melting magnesium furnace as an example, and the method for detecting abnormal working conditions of multi-view data based on feature regression of the present invention is used for detecting abnormal working conditions of the electric melting magnesium furnace in the production process.

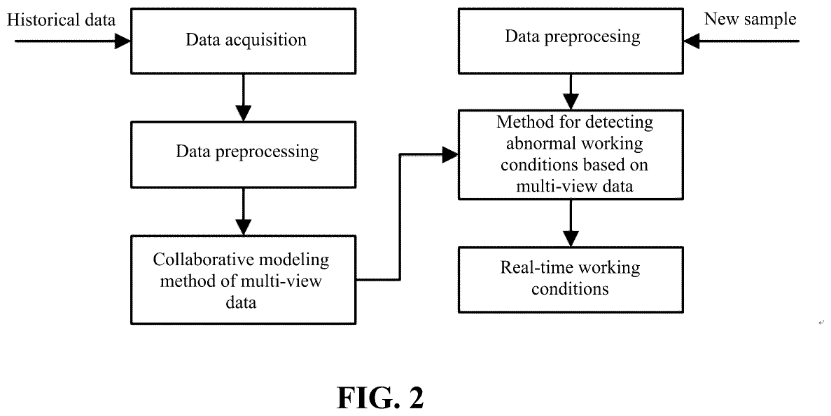

In the embodiment, the method for detecting abnormal working conditions of multi-view data based on feature regression, as shown in FIG. 2, includes the following steps.

Step 1: sample data under different working conditions are acquired in an actual industrial production process, denoted as {Xⱼⁱ|i=1, 2, . . . , w; j=1, 2, . . . , n}, wherein Xⱼⁱ is j^{th} sample data in an i^{th} view, w is the number of views, and n is the number of samples under different views.

In the embodiment, sensors are used for acquiring the sample data of the electric melting magnesium oxide furnace under two working conditions, wherein w=2, n=52, and the number of sample points under normal working conditions is 36.

Step 2: the acquired sample data under different working conditions are preprocessed.

If the sample data Xⱼⁱ in the i^{th} view is image data, firstly graying processing and normalization processing are performed on the image data, then an average value {X̅^{ih}|h=1, 2, . . . , r} of all data under different working conditions is obtained based on the acquired sample data, where r is the number of working condition categories, and further the preprocessed sample data is obtained:

$${X}_{j}^{′ i} = [ {X}_{j}^{i} - {\overline{X}}^{i 1} , {X}_{j}^{i} - {\overline{X}}^{i 2} , … , {X}_{j}^{i} - {\overline{X}}^{ir} ] . \qquad ( 1 )$$

If the sample data Xⱼⁱ∈i^{q×1} in the i^{th} view is vector data, the preprocessed sample data is:

$${X}_{j}^{′ i} = [ \begin{matrix}{e}^{- \frac{\vert {x}_{j 1}^{i} - {\overline{x}}_{i}^{i 1} \vert}{{β}_{1} {σ}_{11}}} & {e}^{- \frac{\vert {x}_{j 1}^{i} - {\overline{x}}_{1}^{i 2} \vert}{{β}_{2} {σ}_{21}}} & … & {e}^{- \frac{\vert {x}_{j 1}^{i} - {\overline{x}}_{1}^{ir} \vert}{{β}_{r} {σ}_{r 1}}} \\ {e}^{- \frac{\vert {x}_{j 2}^{i} - {\overline{x}}_{2}^{i 1} \vert}{{β}_{1} {σ}_{12}}} & {e}^{- \frac{\vert {x}_{j 2}^{i} - {\overline{x}}_{2}^{i 2} \vert}{{β}_{2} {σ}_{22}}} & … & {e}^{- \frac{\vert {x}_{j 2}^{i} - {\overline{x}}_{2}^{ir} \vert}{{β}_{r} {σ}_{r 2}}} \\ ⋮ & ⋮ & ⋱ & ⋮ \\ {e}^{- \frac{\vert {x}_{jq}^{i} - {\overline{x}}_{q}^{i 1} \vert}{{β}_{1} {σ}_{1 q}}} & {e}^{- \frac{\vert {x}_{jq}^{i} - {\overline{x}}_{q}^{i 2} \vert}{{β}_{2} {σ}_{2 q}}} & … & {e}^{- \frac{\vert {x}_{jq}^{i} - {\overline{x}}_{q}^{ir} \vert}{{β}_{r} {σ}_{rq}}}\end{matrix} ] . \qquad ( 2 )$$

Wherein Xⱼ^{ri} represents the preprocessed sample data of the sample data Xⱼⁱ, x_{jq}ⁱ represents a q^{th} variable of the sample data Xⱼⁱ, x̅_{q}^{ir} and σ_{rq} represent an average value and a standard deviation of the q^{th} variable in the i^{th} view under an r^{th} working condition, respectively, and {βⱼ|=1,2, . . . , r} represents coefficient parameter variables under different working conditions.

In the embodiment, original image data are 188×344, and a dimension of the physical variable data is 3×1, β₁=4, β₂=2.

Step 3: after preprocessing the sample data, the method for detecting abnormal working conditions based on the multi-view data is established by the feature regression method, where an objective function model is:

$$L ( {u}^{ij} , {v}^{ij} , {p}^{j} ) = {\sum }_{l = 1}^{n} {\sum }_{i = 1}^{w} {\sum }_{j = 1}^{r} {( {u}^{ij} {X}_{l}^{i} {v}^{ij} - {y}_{l}^{ij} {p}^{j} )}^{2} + {λ}_{2} {\sum }_{i = 1}^{w} {‖ {M}^{i} ‖}_{F}^{2} + {λ}_{1} {\sum }_{i = 1}^{w} {\sum }_{j = 1}^{r} {( {u}^{ij} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{ij} )}^{2} . \qquad ( 3 )$$

Wherein Xₗⁱ Σi^{d×m} is l^{th} preprocessed sample data in the i^{th} view, d and m are dimensions of the sample data Xₗⁱ, and u^{ij}Σi^{l×d} and v^{ij}∈i^{m×1} are the left and right projection vectors, respectively; X_{f}ⁱ and X_{g}ⁱ are f^{th} preprocessed sample data and g^{th} preprocessed sample data in the i^{th} view, respectively; p^{j} is a regression center of the sample data in all views under a j^{th} working condition; yₗ^{ij} is a label of l^{th} sample data in the i^{th} view, if Xₗⁱ belongs to the j^{th} working condition, yₗ^{ij}=1, otherwise, yₗ^{ij}=0; λ₁ and λ₂ are both coefficient parameters.

### Setting

$${\hat{y}}_{l}^{i} = {[ {k}_{l}^{i 1} , {k}_{l}^{i 2} , … {k}_{l}^{ir} ]}^{T} \qquad ( 4 )$$

$$and$$

$${ω}_{l} = {\sum }_{i = 1}^{w} cos 〈 {\hat{y}}_{l}^{i} , {1}_{( r \times 1 )} 〉 \qquad ( 5 )$$

Wherein

$${k}_{l}^{ir} = \frac{{u}^{ij} {X}_{l}^{i} {v}^{ij}}{{p}^{j}} ,$$

for 1=1,2 . . . , n, largest t data labels corresponding to ωₗ constitute a set {Ω}, {C_{f}ⁱ} is a label set of sample data in a same category as the preprocessed sample data X_{f}ⁱ.

### Defining

$$\{ {G}_{f}^{i} \} = \{ {C}_{f}^{i} \} - \{ Ω \} \qquad ( 6 )$$

$$and$$

$${M}^{i} = [ {v}^{i 1} {u}^{i 1} , {v}^{i 2} {u}^{i 2} , … , {v}^{ir} {u}^{ir} ] . \qquad ( 7 )$$

Here, ω^{l} is a solution of the l^{th} sample data. The total number of acquired sample data is n, that is to say, a total of n ωs exist, with different subscripts. The largest t ωₗs selected above are selected sample points with poor effects in the modeling process. These sample points constitute a set {Ω}, it is assumed that fis the sample point included in {Ω}, that is to say, the preprocessed sample data X_{f}ⁱ is the sample points with poor effects in the modeling process, but the preprocessed sample data X_{g}ⁱ is the sample points belonging to the same category as the preprocessed sample data X_{f}ⁱ. These sample points constitute a set {C_{f}ⁱ}, the meaning of the {G_{f}ⁱ}={C_{f}ⁱ}−{Ω} is selecting the data belonging to the same category as the preprocessed sample data X_{f}ⁱ and the sample points that are not included in the set {Ω} to constitute the set. Mⁱ is a data matrix constructed for preventing overfitting.

A first term of the objective function model is to find projection vectors uᵢⱼ and v^{ij} that enable each sample data to approach the label of a sample after dimensionality reduction; a second term uses the square of a Frobenius norm of the matrix Mⁱ as a regularization term to reduce model complexity and minimize overfitting risks; a third item is to find t sample data with unclear classification effects, and increase a distance weight of the sample data with other similar sample data to continuously approach correct category labels, while also have the effect of clustering the data after being mapped by the data of the same category.

In the embodiment, λ₁=λ₂=1, t=10.

Step 3.1: the objective function model is solved.

The above objective function model (3) is decomposed into w×r optimization problems, namely rewritten as:

$$L ( {u}^{ij} , {v}^{ij} , {p}^{j} ) = {\sum }_{l = 1}^{n} {( {u}^{ij} {X}_{l}^{i} {v}^{ij} - {y}_{l}^{ij} {p}^{j} )}^{2} + {λ}_{2} {‖ {v}^{ij} {u}^{ij} ‖}_{F}^{2} + {{λ}_{1} ( {u}^{ij} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{ij} )}^{2} . \qquad ( 8 )$$

Step 3.2: vᵢⱼ and p^{j} are fixed, and u^{ij} is solved.

### Letting

$$T = {\sum }_{f ∈ \{ Ω \}} {ω}_{f} {\sum }_{g ∈ \{ {G}_{f}^{i} \}} ( {X}_{f}^{i} - {X}_{g}^{i} ) . \qquad ( 9 )$$

A partial derivative of formula (8) with respect to uᵢⱼ is taken and the partial derivative is let to be equal to 0 to obtain:

$${u}^{ij} = \frac{{\sum }_{l = 1}^{n} ( {y}_{l}^{ij} {{p}^{j} ( {X}_{l}^{i} {v}^{ij} )}^{T} )}{{{λ}_{2} ( {v}^{ij} )}^{T} {v}^{ij}} \times {\{ \frac{{\sum }_{l = 1}^{n} ( {X}_{l}^{i} {{v}^{ij} ( {X}_{l}^{i} {v}^{ij} )}^{T} ) + {λ}_{1} {{Tv}^{ij} ( {Tv}^{ij} )}^{T}}{{{λ}_{2} ( {v}^{ij} )}^{T} {v}^{ij}} + {I}_{1} \}}^{- 1} . \qquad ( 10 )$$

Where Iₗ is a unit matrix of d×d.

Step 3.3: uᵢⱼ and p^{j} are fixed, and v^{ij} is solved.

A partial derivative of formula (8) with respect to vᵢⱼ is taken and the partial derivative is let to be equal to 0 to obtain:

$${v}^{ij} = {\{ \frac{{\sum }_{l = 1}^{n} ( {( {u}^{ij} {X}_{l}^{i} )}^{T} {u}^{ij} {X}_{l}^{i} ) + {{λ}_{1} ( {u}^{ij} T )}^{T} {u}^{ij} T}{{λ}_{2} {{u}^{ij} ( {u}^{ij} )}^{T}} + {I}_{2} \}}^{- 1} \times \frac{{\sum }_{l = 1}^{n} ( {( {u}^{ij} {X}_{l}^{i} )}^{T} {y}_{l}^{ij} {p}^{j} )}{{λ}_{2} {{u}^{ij} ( {u}^{ij} )}^{T}} . \qquad ( 11 )$$

Where I₂ is a unit matrix of m×m.

Step 3.4: u^{ij} and v^{ij} are fixed, and p^{j} is solved.

The rewritten objective function model (8) is further rewritten as:

$$L ( {p}^{j} ) = {\sum }_{l = 1}^{n} {\sum }_{i = 1}^{w} {( {u}^{ij} {X}_{l}^{i} {v}^{ij} - {y}_{l}^{ij} {p}^{j} )}^{2} . \qquad ( 12 )$$

A partial derivative of formula (12) with respect to p^{j} is taken and the partial derivative is let to be equal to 0 to obtain:

$${p}^{j} = \frac{{\sum }_{l = 1}^{n} {\sum }_{i = 1}^{w} {( {y}_{l}^{ij} {u}^{ij} {X}_{l}^{i} {v}^{ij} )}^{2}}{{\sum }_{l = 1}^{n} {\sum }_{i = 1}^{w} {y}_{l}^{ij}} . \qquad ( 13 )$$

Step 3.5: the obtained u^{ij}, v^{ij} and p^{j} are used for next iteration and loop iteration is performed until the objective function model converges to a minimum value or satisfies termination conditions.

Step 3.5.1: ωₗ, {Ω} and {G_{f}ⁱ} are solved respectively, through formulas (4), (5) and (6).

Step 3.5.2: u^{ij} is solved through formula (10).

Step 3.5.3: v^{ij} is solved through formula (11).

Step 3.5.4: p^{j} is solved through formula (13).

Step 3.5.5: whether the termination conditions are satisfied is determined, if yes, u^{ij}, v^{ij} and p^{j} are output, or else, Steps 3.5.1-3.5.4 are repeated.

In the embodiment, the termination conditions are that a difference value between objective functions of two adjacent iterations is less than a set threshold (less than 10⁻¹⁵) or the number of iterations reaches an upper limit value, and in the embodiment, it is 50 iterations.

Step 4: on-line abnormal working condition detection is performed by the method for detecting abnormal working conditions based on the multi-view data.

Sample data {X_{new}ⁱ|i=1, 2, . . . , w} at a certain time are acquired, and preprocessing is performed by the data preprocessing method in Step 2; dimensionality reduction is performed on the sample data at the certain time by using the left projection vector u^{ij} and the right projection vector v^{ij} obtained from Step 3, and a vector y_{new} after the dimensionality reduction is constituted; data category vectors y* are selected according to requirements, wherein for the data category vectors, since sample point data at every time can only belong to one category, for each view, only one data category vector is 1, and the rest are 0; therefore, for the data category vectors y*, w 1s exist, all other w×(r−1) variables are 0; wherein

$${y}_{new} = {[ \begin{matrix}\frac{{u}^{11} {X}_{new}^{1} {v}^{11}}{{p}^{1}} & \frac{{u}^{12} {X}_{new}^{1} {v}^{12}}{{p}^{2}} & … & \frac{{u}^{1 r} {X}_{new}^{1} {v}^{1 r}}{{p}^{r}} & \frac{{u}^{21} {X}_{new}^{2} {v}^{21}}{{p}^{1}} & … & \frac{{u}^{wr} {X}_{new}^{w} {v}^{wr}}{{p}^{r}}\end{matrix} ]}^{T} \qquad ( 14 )$$

$$and$$

$${y}^{*} = {[ \begin{matrix}{y}^{11} & {y}^{12} & … & {y}^{1 r} & {y}^{21} & … & {y}^{wr}\end{matrix} ]}^{T} . \qquad ( 15 )$$

Based on similarity between y_{new} and y*, a category of working conditions is determined at the certain time, and cosine similarity is used as a detection index, where a calculation method of the detection index is:

$${CS}_{new} = 1 - cos 〈 {y}_{new} , y * 〉 . \qquad ( 16 )$$

By comparing values of detection indexes of different data category vectors y* and y_{new}, working conditions at a current time are determined, wherein the smaller the values of the detection indexes, the greater a correlation between y* and y_{new}; due to different data category vectors y* under different working conditions, working conditions corresponding to the data category vector with a smallest value of the detection index are selected as working conditions at the current time.

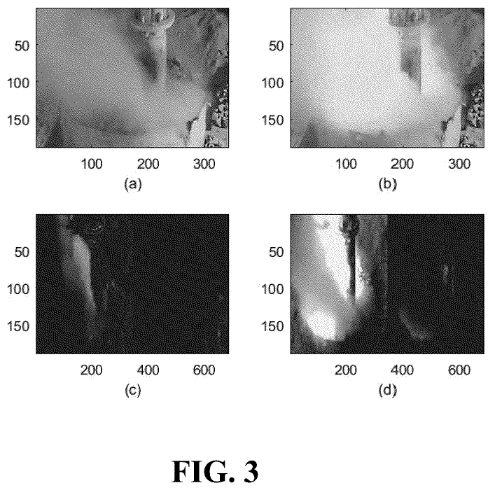

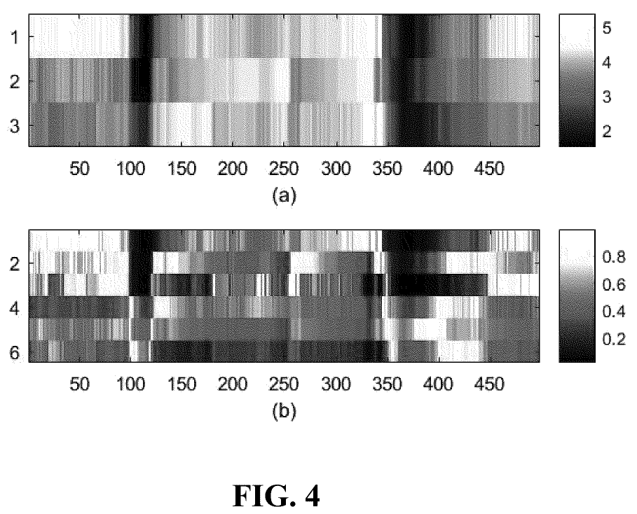

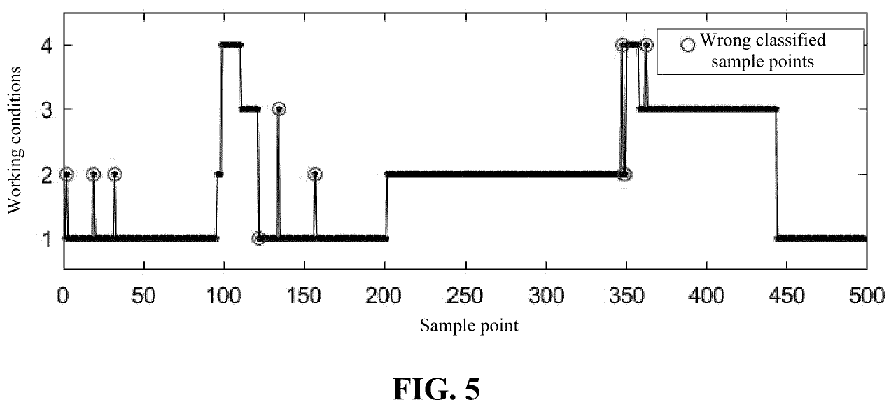

In the embodiment, in the sample data, a total of 498 sample points are acquired in the continuous production process of electric molten magnesium oxide, wherein, anomalies exist in 96^{th}-110^{th} sample points and 202^{nd}-357^{th} sample points of the image data, and anomalies exist in the 99^{th}-122^{nd} and 348^{th}-433^{rd} sample points of physical variable data. The image data and preprocessed image data are shown in FIG. 3. The original data and processed data of the physical variable data of samples, and data transformed into vectors, are shown in FIG. 4. The final detection results are shown in FIG. 5, and a detection accuracy rate is 97.791%.

Finally, it should be noted that the above embodiments are only used to illustrate the technical solution of the present invention, and not to limit it. Although the present invention has been described in detail with reference to the aforementioned embodiments, those skilled in the art should understand that it is still possible to modify the technical solution recorded in the aforementioned embodiments, or to equivalently replace some or all of the technical features thereof, and these modifications or replacements do not make the essence of the corresponding technical solution deviate from the scope limited by the claims of the present invention.

1. A method for detecting abnormal working conditions of multi-view data based on feature regression, comprising:
acquiring sample data under different working conditions in an industrial production process, and preprocessing the acquired sample data;
establishing the method for detecting abnormal working conditions based on the multi-view data by a feature regression method; and
performing an on-line abnormal working condition detection by the method for detecting abnormal working conditions based on the multi-view data;
the method comprising the following steps:
Step 1: acquiring the sample data under different working conditions in an actual industrial production process, denoted as {Xⱼⁱ|t=1, 2 . . . , w; ⱼⁱ=1, 2, . . . , n}, wherein Xⱼⁱ is j^{th} sample data in an i^{th} view, w is the number of views, and n is the number of samples under different views;
Step 2: preprocessing the acquired sample data under different working conditions;
Step 3: after preprocessing the sample data, establishing the method for detecting abnormal working conditions based on the multi-view data by the feature regression method; and
Step 4: performing the on-line abnormal working condition detection by the method for detecting abnormal working conditions based on the multi-view data,
wherein Step 2 comprises:
if the sample data Xⱼⁱ in the i^{th} view is image data, firstly performing graying processing and normalization processing on the image data, then obtaining an average value {X̅^{th}|h=1, 2, . . . , r} of all data under different working conditions according to the acquired sample data, wherein r is the number of working condition categories, and further obtaining the preprocessed sample data:
$${X}_{j}^{′ i} = [ {X}_{j}^{i} - {\overline{X}}^{i 1} , {X}_{j}^{i} - {\overline{X}}^{i 2} , … , {X}_{j}^{i} - {\overline{X}}^{ir} ] , \qquad ( 1 )$$
and if the sample data Xⱼⁱ∈i^{q×l} in the i^{th} view is vector data, the preprocessed sample data is:
$${X}_{j}^{′ i} = [ \begin{matrix}{e}^{- \frac{\vert {x}_{j 1}^{i} - {\overline{x}}_{1}^{i 1} \vert}{{β}_{1} {σ}_{11}}} & {e}^{- \frac{\vert {x}_{j 1}^{i} - {\overline{x}}_{1}^{i 2} \vert}{{β}_{2} {σ}_{21}}} & ⋯ & {e}^{- \frac{\vert {x}_{j 1}^{i} - {\overline{x}}_{1}^{ir} \vert}{{β}_{r} {σ}_{r 1}}} \\ {e}^{- \frac{\vert {x}_{j 2}^{i} - {\overline{x}}_{2}^{i 1} \vert}{{β}_{1} {σ}_{12}}} & {e}^{- \frac{\vert {x}_{j 2}^{i} - {\overline{x}}_{2}^{i 2} \vert}{{β}_{2} {σ}_{22}}} & ⋯ & {e}^{- \frac{\vert {x}_{j 2}^{i} - {\overline{x}}_{2}^{ir} \vert}{{β}_{r} {σ}_{r 2}}} \\ ⋮ & ⋮ & ⋱ & ⋮ \\ {e}^{- \frac{\vert {x}_{jq}^{i} - {\overline{x}}_{q}^{i 1} \vert}{{β}_{1} {σ}_{1 q}}} & {e}^{- \frac{\vert {x}_{jq}^{i} - {\overline{x}}_{q}^{i 2} \vert}{{β}_{2} {σ}_{2 q}}} & ⋯ & {e}^{- \frac{\vert {x}_{jq}^{i} - {\overline{x}}_{q}^{ir} \vert}{{β}_{r} {σ}_{rq}}}\end{matrix} ] , \qquad ( 2 )$$
wherein Xⱼ^{ri} represents the preprocessed sample data of the sample data Xⱼⁱ, x_{jq}ⁱ represents a q^{th} variable of the sample data Xⱼⁱ, x̅_{q}^{ir} and σ_{rg} represent an average value and a standard deviation of the q^{th} variable in the i^{th} view under a r^{th} working condition, respectively, and {βⱼ|j=1, 2, . . . , r} represents coefficient parameter variables under different working conditions,
wherein in Step 3, an objective function model in the method for detecting abnormal working conditions based on the multi-view data established by the feature regression method is:
$$L ( {u}^{ij} , {v}^{ij} , {p}^{j} ) = {\sum }_{l = 1}^{n} {\sum }_{i = 1}^{w} {\sum }_{j = 1}^{r} {( {u}^{ij} {X}_{l}^{i} {v}^{ij} - {y}_{l}^{ij} {p}^{j} )}^{2} + {λ}_{2} {\sum }_{i = 1}^{w} {‖ {M}^{i} ‖}_{F}^{2} + {λ}_{1} {\sum }_{i = 1}^{w} {\sum }_{j = 1}^{r} {( {u}^{ij} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{ij} )}^{2} , \qquad ( 3 )$$
wherein Xⱼⁱ ∈i^{d×m} is l^{th} preprocessed sample data in the i^{th} view, d and m are dimensions of the sample data Xⱼⁱ, and u^{ij}∈_{1×d and v}^{ij}∈i^{m×1} are left and right projection vectors, respectively; X_{f}^{t} and X_{g}^{r} are f^{th} preprocessed sample data and g^{th} preprocessed sample data in the i^{th} view, respectively; p^{j} is a regression center of the sample data in all views under a j^{th} working condition; yₗ^{ij} is a label of l^{th} sample data in the i^{th} view, if Xₗⁱ belongs to the j^{th} working condition, yₗ^{ij}=1, otherwise, yₗ^{ij}=0; λ₁ and λ₂, are both coefficient parameters;
setting
$${\hat{y}}_{l}^{i} = {[ {k}_{l}^{i 1} , {k}_{l}^{i 2} , ⋯ {k}_{l}^{ir} ]}^{T} \qquad ( 4 )$$
$$and$$
$${ω}_{l} = {\sum }_{i = 1}^{w} cos 〈 {\hat{y}}_{l}^{i} , {1}_{( r \times 1 )} 〉 , \qquad ( 5 )$$
wherein
$${k}^{ir} = \frac{{u}^{ij} {X}_{l}^{i} {v}^{ij}}{pj} ,$$
for l=1, 2 . . . , n, largest t data labels corresponding to ωₗ constitute a set {Ω}, {C_{f}ⁱ} is a label set of sample data in a same category as the preprocessed sample data X_{f}ⁱ;
defining
$$\{ {G}_{f}^{i} \} = \{ {C}_{f}^{i} \} - \{ Ω \} \qquad ( 6 )$$
$$and$$
$${M}^{i} = [ {v}^{i 1} {u}^{i 1} , {v}^{i 2} {u}^{i 2} , ⋯ , {v}^{ir} {u}^{ir} ] . \qquad ( 7 )$$

2. (canceled)

3. (canceled)

4. (canceled)

5. The method according to claim 1, wherein Step 3 comprises:
Step 3.1: solving the objective function model;
wherein the objective function model (3) is decomposed into w×r optimization problems, namely rewritten as:
$$L ( {u}^{ij} , {v}^{ij} , {p}^{j} ) = {\sum }_{l = 1}^{n} {( {u}^{ij} {X}_{l}^{i} {v}^{ij} - {y}_{l}^{ij} {p}^{j} )}^{2} + {λ}_{2} {‖ {v}^{ij} {u}^{ij} ‖}_{F}^{2} + {λ}_{1} {( {u}^{ij} {\sum }_{f ∈ \{ Ω \}} {ω}_{f} {\sum }_{g ∈ \{ {G}_{f}^{i} \}} ( {X}_{f}^{i} - {X}_{g}^{i} ) {v}^{ij} )}^{2}$$
Step 3.2: fixing vᵢⱼ and pⱼ, and solving uᵢⱼ;
letting
$$T = {\sum }_{f ∈ \{ Ω \}} {ω}_{f} {\sum }_{g ∈ \{ {G}_{f}^{i} \}} ( {X}_{f}^{i} - {X}_{g}^{i} ) , \qquad ( 9 )$$
taking a partial derivative of formula (8) with respect to uᵢⱼ and letting the partial derivative be equal to 0 to obtain:
$${u}^{ij} = \frac{{\sum }_{l = 1}^{n} ( {y}_{l}^{ij} {p}^{j} {( {X}_{l}^{i} {v}^{ij} )}^{T} )}{{λ}_{2} {( {v}^{ij} )}^{T} {v}^{ij}} \times {\{ \frac{{\sum }_{l = 1}^{n} ( {X}_{l}^{i} {{v}^{ij} ( {X}_{l}^{i} {v}^{ij} )}^{T} ) + {λ}_{1} T {{v}^{ij} ( T {v}^{ij} )}^{T}}{{λ}_{2} {( {v}^{ij} )}^{T} {v}^{ij}} + {I}_{1} \}}^{- 1} , \qquad ( 10 )$$
wherein I₁ is a unit matrix of d×d;
Step 3.3: fixing u^{ij} and p^{j}, and solving v^{ij};
Taking a partial derivative of formula (8) with respect to v^{ij} and letting the partial derivative be equal to 0 to obtain:
$${v}^{ij} = {\{ \frac{{\sum }_{l = 1}^{n} ( {( {u}^{ij} {X}_{l}^{i} )}^{T} {u}^{ij} {X}_{l}^{i} ) + {{λ}_{1} ( {u}^{ij} T )}^{T} {u}^{ij} T}{{λ}_{2} {{u}^{ij} ( {u}^{ij} )}^{T}} + {I}_{2} \}}^{- 1} \times \frac{{\sum }_{l = 1}^{n} ( {( {u}^{ij} {X}_{l}^{i} )}^{T} {y}_{l}^{ij} {p}^{j} )}{{λ}_{2} {{u}^{ij} ( {u}^{ij} )}^{T}} , \qquad ( 11 )$$
wherein I₂ is a unit matrix of m×m;
Step 3.4: fixing uᵢⱼ and vᵢⱼ, and solving pⱼ;
further rewriting the rewritten objective function model (8) as:
$$L ( {p}^{j} ) = {\sum }_{l = 1}^{n} {\sum }_{i = 1}^{w} {( {u}^{ij} {X}^{j} , {v}^{ij} - {y}_{l}^{ij} {p}^{j} )}^{2} , \qquad ( 12 )$$
taking a partial derivative of formula (12) with respect to pⱼ and letting the partial derivative be equal to 0 to obtain:
$${p}^{j} = \frac{{\sum }_{l = 1}^{n} {\sum }_{i = 1}^{w} {( {y}_{l}^{ij} {u}^{ij} {X}_{l}^{i} {v}^{ij} )}^{2}}{{\sum }_{l = 1}^{n} {\sum }_{i = 1}^{w} {y}_{l}^{ij}} ; \qquad ( 13 )$$
and
Step 3.5: using the obtained u^{ij}, vᵢⱼ and p^{j} for next iteration and performing loop iteration until the objective function model converges to a minimum value or satisfies termination conditions.

6. The method according to claim 5, wherein Step 3.5 comprises:
Step 3.5.1: solving ω₁, {ω} and {G_{f}ⁱ}, respectively, through formulas (4), (5) and (6);
Step 3.5.2: solving u^{ij} through formula (10);
Step 3.5.3: solving v^{ij} through formula (11);
Step 3.5.4: solving p^{j} through formula (13);
Step 3.5.5: determining whether the termination conditions are satisfied, if yes, outputting u^{ij}, v^{ij} and p^{j}, or else, repeating Steps 3.5.1-3.5.4.

7. The method according to claim 6, wherein Step 4 comprises:
acquiring sample data new {X_{new}ⁱ|i=1, 2, . . . , w} at a certain time, and performing preprocessing by the data preprocessing method in Step 2; performing dimensionality reduction on the sample data at the certain time by using the left projection vector uᵢⱼ and the right projection vector vi obtained from Step 3, and constituting a vector y_{new} after the dimensionality reduction; selecting data category vectors y* according to requirements, wherein for the data category vectors, since sample point data at every time only belong to one category, for each view, only one data category vector is 1, and the rest are 0; therefore, for the data category vectors y*, w 1s exist, all other w×(r−1) variables are 0; wherein
$${y}_{new} = {[ \frac{{u}^{11} {X}_{new}^{1} {v}^{11}}{{p}^{1}} \frac{{u}^{12} {X}_{new}^{1} {v}^{12}}{{p}^{2}} ⋯ \frac{{u}^{1 r} {X}_{new}^{1} {v}^{1 r}}{{p}^{r}} \frac{{u}^{21} {X}_{new}^{2} {v}^{21}}{{p}^{1}} ⋯ \frac{{u}^{wr} {X}_{new}^{w} {v}^{wr}}{{p}^{r}} ]}^{T} \qquad ( 14 )$$
$$and$$
$$y *= {[ \begin{matrix}{y}^{11} & {y}^{12} & ⋯ & {y}^{1 r} & {y}^{21} & ⋯ & {y}^{wr}\end{matrix} ]}^{T} , \qquad ( 15 )$$
based on similarity between y_{new} and y*, determining a category of working conditions at the certain time, and using cosine similarity as a detection index, wherein a calculation method of the detection index is:
$${CS}_{new} = 1 - cos 〈 {y}_{new} , y * 〉 , \qquad ( 16 )$$
by comparing values of detection indexes of different data category vectors y* and y_{new}, determining working conditions at a current time, wherein the smaller the values of the detection indexes, the greater a correlation between y* and y_{new}; due to different data category vectors y* under different working conditions, working conditions corresponding to the data category vector with a smallest value of the detection index are selected as working conditions at the current time.
